(19) United States
(12) Patent Application Publication
(10) Pub. No.: US 2006/0086256 A1
(43) Pub. Date: Apr. 27, 2006

(54) Device for preparing hot beverages

(76) Inventor: Bernd Heinze, Konigsee (DE)

Correspondence Address: BACON & THOMAS, PLLC, 625 SLATERS LANE, FOURTH FLOOR, ALEXANDRIA, VA, 22314, US

(21) Appl. No.: 10/527,171

(22) PCT Filed: Sep. 12, 2003
(86) PCT No.: PCT/EP03/10169

§ 371 Date: Sep. 2, 2005

(30) Foreign Application Priority Data
Sep. 13, 2002 (DE) 102 42 634.1

(51) Int. Cl. A47J 31/00

(52) U.S. Cl. 99/279

(57) ABSTRACT

A device for preparing hot beverages includes a water container (14), which is located on a first base plate (11), can be removed from said base plate and has a first heating device (37) for heating the water in the container, a filter unit (22) for receiving ground coffee or tea leaves, elements (25, 35) for conveying water from the water container (14) to the filter unit (22), the elements (25, 35) for conveying water having a second heating device (36) for heating the water to be conveyed, and a receiving pot (21), located downstream of the filter unit (22). The water container (14) can be selectively placed in a first position, in which said water (14) acts as a reservoir for the water to be conveyed to the filter unit (22), or a second position that is preferably offset at an angle in relation to the first position, in which the water container (14) acts as a kettle. If the water container is removed, other cordless kitchen equipment, such as egg boilers or toasters can be placed on said base plate (11).

The present invention relates to a device for preparing hot beverages as claimed in the precharacterizing clause of the present patent claim 1.

Devices for preparing hot beverages, in particular electrically operated devices, are known in a very-wide variety of forms, for example as coffee or espresso machines, as tea percolators or else as simple kettles which are used merely to heat water which is then poured, for example, into prepared vessels for brewing beverages, soups and the like. Nowadays, numerous electrical appliances for preparing meals and beverages can be found in modern households and are often used daily and therefore are usually always kept ready on the work surfaces and worktops in the kitchen. In addition to the abovementioned appliances, toasters, egg boilers, juicers and mixers may be mentioned by way of example. In view of the space required by these frequently used electrical appliances, and of the need for each individual appliance to have a separate connection to the mains, the aim is to combine as many kitchen appliances as possible in a practical manner so as to form what are known as multipurpose appliances.

Therefore, for example, the German utility model DE 297 04 023 U1 describes a coffee machine whose base plate can be electrically and mechanically connected to suitable base plates for further domestic appliances. This document thus describes, for example, a multipurpose appliance comprising a coffee machine and a kettle. However, the two appliances are essentially conventional individual appliances which can access a common power supply sorely through the electrical connection of their base plates, so that only one mains plug is required for the operation of both appliances. However, in the case of the known appliance, a separate water reservoir container is provided for the coffee machine, in addition to the kettle, with the result that the space required is not appreciably reduced as compared to conventional individual appliances.

German patent application DE 198 57 165 A1 describes a device for preparing hot beverages as claimed in the precharacterizing clause of the present claim 1. The device described there comprises a combination of a coffee machine and a kettle, the kettle simultaneously being used as a water reservoir container for the coffee machine. It is a disadvantage of this multipurpose appliance that the entire contents of the kettle are also heated when the appliance is used solely as a coffee machine. This not only represents a considerable source of danger because the removable kettle, which is always filled with hot water even when coffee is being prepared, may be unintentionally knocked over, but is also associated with an unnecessary consumption of energy, in particular when the water reservoir container is almost full but only a few cups of coffee are to be made.

DE 299 20 890 U1 discloses a coffee machine having a removable water container which has a heating coil in the interior, it being possible to switch over between coffee mode and the preparation of hot water by means of a switch provided on a base of the appliance. In this case, both the electrical contacts and a connecting valve between water container and coffee filter must be actuated by means of the switch.

The present invention is therefore based on the technical problem of providing a device for preparing hot beverages which may optionally be used to brew coffee or tea or to heat water, the intention being to make it possible for the user to separately set these two modes of operation easily and intuitively. In particular, the device according to the invention should require as little space as possible.

This technical problem is solved by the device for preparing hot beverages having the features of the present claim 1. The invention is based on the idea of switching over between operation of the device for brewing coffee or tea, on the one hand, and for heating water, on the other hand, solely by arranging the water container, which is used simultaneously as a kettle and as a reservoir container for the coffee machine, differently on its base plate.

Accordingly, the subject matter of the invention is a device for preparing hot beverages having a water container which is arranged on a first base plate, can be removed from the base plate and has a first heating device for heating the water contained in the water container, having a filter unit which receives ground coffee or tea leaves, having means for transferring water originating from the water container into the filter unit, the means for transferring the water having a second heating device for heating the water to be transferred, and having a receiving vessel arranged downstream of the filter unit, the device according to the invention being characterized in that the water container can optionally be positioned in a first position, in which the water container is used as a reservoir container for the water to be transferred into the filter unit, or in a second position, in which the water container is used as a kettle.

By the different position of the water container, the user can tell at first glance which mode of operation the device according to the invention is in at any given time, without having to look at indicator lamps or, in contrast to the coffee machine described in German utility model DE 299 20 890 U1, at specific switch positions. Once the water container has been refilled with water, the user can thus specify the mode of operation just by placing the water container on the base plate in the respective position, without having to operate further switches or setting buttons.

In the first position the water container is particularly preferably offset at an angle in relation to the second position. The user can thus specify the respective mode of use by simply turning the water container in relation to the base plate. In the second position the water container is particularly preferably turned substantially through 90° with respect to the first position. By way of example, the device according to the invention can be designed such that the water container is in the mode of operation as a kettle, that is to say in the second position, with its handle oriented toward the user, when said water container is typically arranged on the kitchen work surface, while in the mode of operation as a water reservoir container for preparing tea or coffee, that is to say in the first position, the handle is turned away through 90° from the user. The different modes of use can thus be intuitively identified.

When, in the present context, two different positions of the water container are mentioned, this is thus to be understood in the sense of “at least” two different positions, since it may also be provided, for example, that, starting from the first position in which the device functions as a coffee machine, the mode of operation as a kettle is reached both upon turning the water container through 90° in the counter-clockwise direction and upon turning the water container through 90° in the clockwise direction, with the result that in this example, in addition to the position for preparing coffee or tea, there would be two further positions in which the device functions as a kettle. Apart from positions rotated with respect to one another, other changes in position of the water container, for example moving to the side on the base plate, can also be realized in accordance with the invention. However, on account of the little space required by the resulting device, turning the water container between the two positions of operation is particularly preferred.

The detailed technology behind coffee machines and kettles is known to the person skilled in the art and does not need to be repeated here. The device according to the invention makes use of the known technology and is distinct from a conventional coffee machine only in that the water reservoir container of the coffee machine is designed as a removable cordless kettle and is provided with all of the features known from kettles, such as steam switch-off and, in particular, a very wide variety of overheating-protection devices.

In the mode of operation as a water reservoir container for brewing coffee or tea, a communicating connection must therefore initially be ensured between the interior of the water container and the means for transferring water out of the water container into the filter unit. For this purpose, preferably in the bottom region, the water container has an outlet opening which can be closed by a self-closing valve. The valve device ensures that no water can escape from the container through the outlet opening when the water container is lifted off from the base plate. The base plate and the lower side of the water container are preferably designed such that the self-closing valve device is only opened when the water container is arranged in the first position. For this purpose, the means for transferring the water preferably issue into an inlet nozzle which is provided on the upper side of the first base plate and opens the valve device when the water container is arranged in the first position. For this purpose, the inlet nozzle may have, for example, a mandrel which engages in the outlet opening arranged in the bottom region of the water container and actuates the self-closing valve device which, for example, may be designed as a spring-loaded nonreturn valve.

The means for transferring the water also preferably have a nonreturn valve which is connected downstream of the inlet nozzle, that is to say, for example, arranged between the inlet nozzle and the second heating device for heating the water which is to be transferred. This nonreturn valve ensures that no water which has already been removed from the water container and possibly already heated in the second heating device can flow back and escape from the inlet nozzle when the water container is lifted off from the base plate.

The means for transferring the water preferably comprise lines and/or hoses which connect the inlet nozzle to the second heating device which, as known from coffee machines, may advantageously be designed as a through-flow heater. Further line connections, for example a riser pipe, are connected to the second heating device, said further line connections finally ending in a manner known per se in suitable drip devices which are arranged above the filter unit. After the water has passed the filter unit, which had previously been filled with ground coffee or tea leaves, the resulting brew is received by the receiving vessel, that is to say, for example, a coffeepot or teapot.

The water container of the device according to the invention is preferably designed as a cordless kettle. For this purpose, electrical supply means are provided in the first base plate and are in electrical contact with the first heating device, which is preferably arranged in the bottom region of the water container, by means of a detachable contact in the second position of the water container. The detachable contact-making means preferably comprise a 360° connector which is arranged on the upper side of the first base plate and interacts with a complementary socket which is arranged on the lower side of the water container. Connectors of this type are known and are described, for example, in the international patent application WO 95/08204 from Strix. The 360° connector makes it particularly easy to turn the water container from the first position into the second position and vice versa, without having to completely lift the water container off from the base plate. The electrical contact is preferably interrupted in the first position of the water container, that is to say in the position in which the device functions as a coffee machine. When a 360° connector is used, care must preferably be taken that the connector and the complementary socket, which is arranged on the lower side of the water container, are sufficiently spaced apart from one another in the first position such that the electrical contact between connector and socket is interrupted. In this case, the upper side of the first base plate and/or the lower side of the water container are/is preferably profiled such that the electrical contact is interrupted when the water container is turned from the second position into the first position, or is not even made in the first place when the water container is placed in the first position. For this purpose, knobs may be provided, for example, on the lower side of the water container, which in the second position may engage in suitably arranged, complementary depressions on the upper side of the base plate such that the electrical contact between connector and socket is ensured. In every other position, in particular in the first position, the knobs are situated on the flat upper side of the base plate and thus ensure the necessary spacing between connector and socket so that the electrical contact is interrupted. Suitably positioned contacts can correspondingly even ensure that the coffee machine cannot be switched on if the water container is in the second position, that is to say is functioning as a kettle.

The receiving container, that is to say, for example, a coffeepot or teapot, can be freely positioned beneath the filter unit by the user. However, a second base plate is preferably provided for the receiving container and ensures that the receiving container can be positioned as centrally as possible beneath an outlet opening of the filter unit. The second base plate may comprise, for example, an electrically heated warming plate which keeps the brewed beverage warm until it is consumed. The first and second base plates are preferably connected to one another to form a common base of the device according to the-invention, the base being designed, for example, as a one-piece plastic molding in which operating and display elements which are known per se can be integrated.

According to a further embodiment, the water container may, however, also be arranged above the filter unit, this particularly reducing the space required by the device according to the invention. The first base plate is then arranged between filter unit and water container such that the means for transferring water originating from the water container into the filter unit can be designed in a particularly simple manner since, for example, a riser pipe can be dispensed with.

The filter unit and, in the second embodiment of the device according to the invention, also the first base plate can be fixed to at least one profiled pipe which runs vertically, for example to a metal pipe. This permits particularly simple adaptation to different pot sizes during production, since it is only necessary to correspondingly adapt the length of the profiled pipe whilst the other components remain unchanged. According to a further embodiment, the filter unit may be detachably fixed to the profiled pipe such that the user can also adapt the height of the device to a certain extent if, for example, a relatively tall thermos flask rather than a shallow coffeepot is to be filled with coffee. For this purpose, however, it must be ensured that the pipe or hose connections of the means for transferring the water are also designed such that they can be correspondingly adapted.

According to a preferred embodiment of the device according to the invention, a further electrically operated cordless kitchen appliance may be arranged on the base plate if the water container is removed. This additional appliance is preferably a cordless toaster or a cordless egg boiler. In this case, the base plate of the additional cordless appliance or else the housing the respective electrical connections of base plate and appliance may be designed such that the appliance can only be positioned on the base plate in that position in which the electrical supply means of the base plate are in electrical contact with complementary contact-making means which are provided in the base plate. However, any desired orientation of the additional appliances can also be made possible. The electrical contact-making means of the base plate of the additional appliances can have a socket for a 360° connector, as already described in conjunction with the kettle.

The device according to the invention is described in greater detail below with reference to exemplary embodiments which are illustrated in the attached drawings, in which;

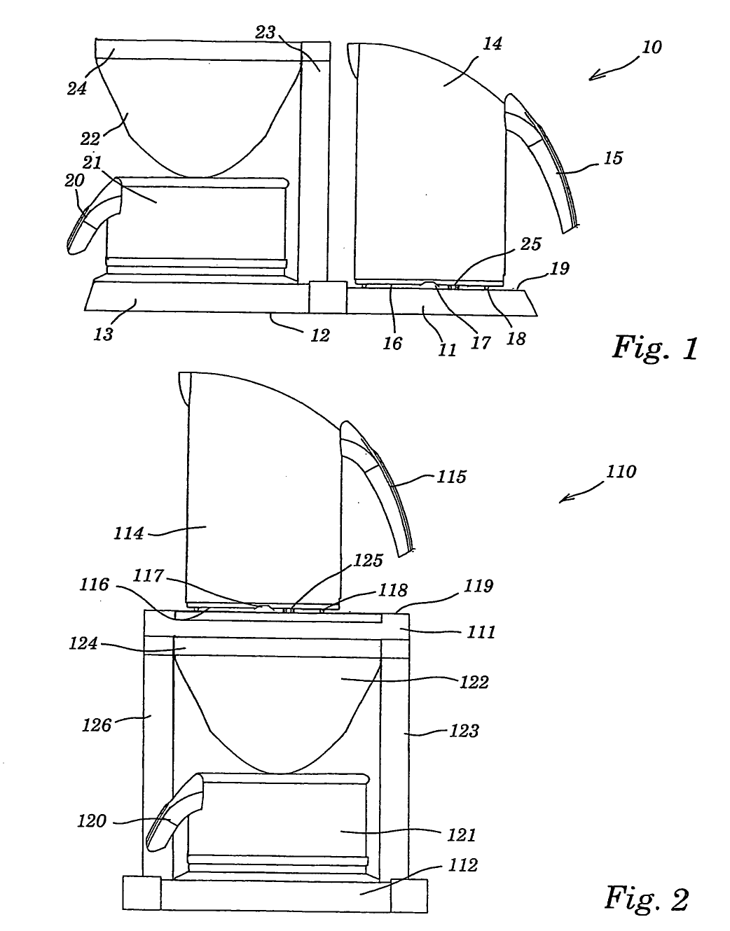

FIG. 1 shows a schematic illustration of a first embodiment of the device according to the invention;

FIG. 2 shows a schematic illustration of a second embodiment of the device according to the invention;

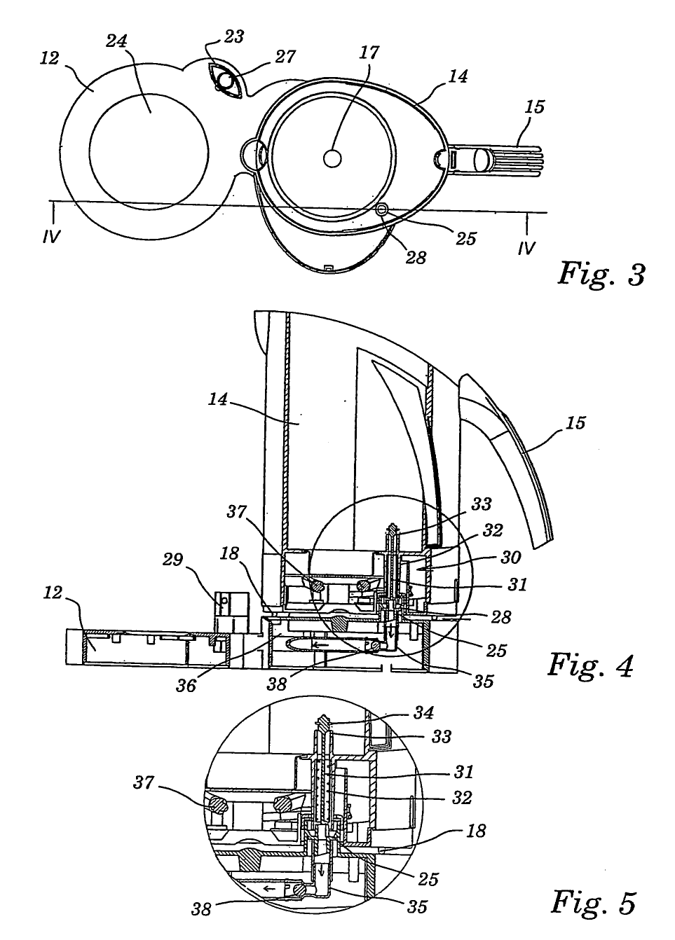

FIG. 3 shows a view of the first embodiment of the device according to the invention, with the water container in the first position;

FIG. 4 shows a longitudinal section along line IV-IV of the device from FIG. 3;

FIG. 5 shows a detailed view of the illustration of FIG. 4;

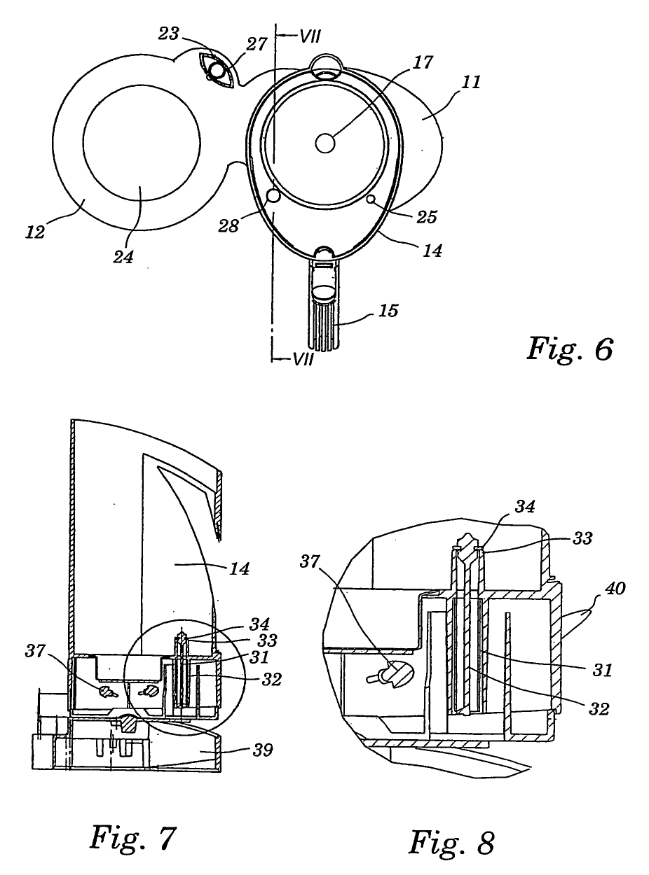

FIG. 6 shows a view of the first embodiment of the device according to the invention, with the water container in the second position;

FIG. 7 shows a longitudinal section along line VII-VII of the device from FIG. 6;

FIG. 8 shows a detailed view of the illustration of FIG. 7;

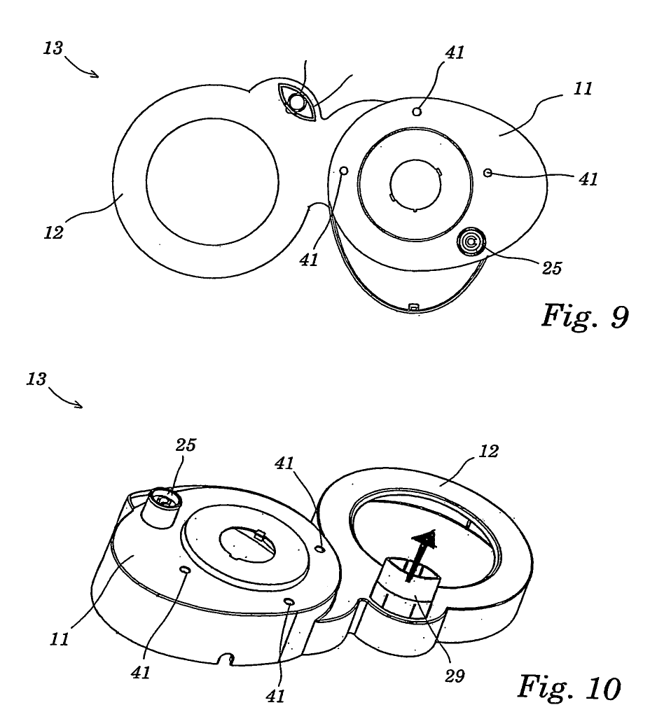

FIG. 9 shows a view of the base of the device from FIG. 1; and

FIG. 10 shows a schematic, perspective illustration of the base from FIG. 9.

FIG. 1 shows a first embodiment of the device according to the invention for preparing hot beverages, which is designated as a whole by the reference numeral 10. The device 10 comprises an appliance base 13 which consists of a first base plate 11 and a second base plate 12 and which has operating and display elements (not shown in the schematic illustration of FIG. 1) and comprises the appliance electronics and the electrical supply devices, that is to say, in particular, a mains cable and optionally transformers. The base 13 may be composed in a modular manner of the two base plates or, for example, be designed as a one-piece plastic molding. A removable water container 14 having a handle 15 is arranged on the first base plate and is designed as a cordless kettle. The water container 14 can be arranged in at least two different positions on the first base plate 11, in the illustration of FIG. 1 the water container being in the first position in which it is used as a water reservoir container for the coffee machine. For operation as a kettle, the water container 14 has on its lower side 16 a detachable contact 17 with which a first heating device which is arranged in the bottom region of the container 14 and cannot be seen in the illustration of FIG. 1 can be connected to the electrical supply devices of the base plate 11. The detachable contact 17 is interrupted in the illustrated first position. For this purpose, the water container 14 has, on its lower side 16, knobs 18 which rest on the upper side 19 of the base plate 11 in the first position and which lift the water container to such an extent that the electrical contact 17 is interrupted. In the second position of the water container 14 (cf. FIG. 6), the knobs 18 engage in depressions, which are made on the upper side 19 of the base plate 11, such that the container 14 is somewhat lowered and the contact is produced (cf. FIG. 10). A coffeepot 21 which is provided with a handle 20 is arranged on the second base plate 12 as a receiving vessel. A filter unit 22 is arranged above the coffeepot 16, can receive ground coffee or tea leaves and is fixed to a profiled pipe 23 made of metal such that it can pivot. A riser pipe (not visible here) for the water heated by a second heating device, for example a through-flow heater, which is arranged in the base 13 runs in the profiled pipe 23, the water then being passed into a drip device 24 provided above the filter unit 22. The water which is to be heated is removed from the water container 14 via an opening, which is provided on the lower side 16 of the container, by means of an inlet nozzle 25 which issues from the upper side 19 of the base plate 11, as explained in more detail with reference to the illustrations of FIGS. 4 and 5.

FIG. 2 shows a particularly space-saving second embodiment of the device according to the invention which is designated as a whole by the reference numeral 110. Components which fulfill the same or corresponding functions as the components of the embodiment from FIG. 1 are designated by the same reference numerals but increased by 100 and are not explained in any more detail here. In the embodiment from FIG. 2, the first base plate 111 and the removable water container 114 are arranged above the coffeepot 121 and the filter unit 122. In this second embodiment, the water container 114 can also be arranged in at least two positions on the base plate 111 and is optionally used as a kettle or as a water reservoir container for preparing coffee or tea, the first position of the water container being shown in the illustration of FIG. 2, as is also the case in FIG. 1. In the illustrated example, a further profiled pipe 126 made of metal is provided in addition to the profiled metal pipe 123 for reasons of stability, these two pipes extending upward starting from the second base plate 112 and bearing the first base plate 111.

For the sake of simplicity, the invention is explained below solely with reference to the first embodiment, which is illustrated in FIG. 1, since the mode of functioning of the second embodiment, which is illustrated in FIG. 2, is readily apparent from these explanations.

FIG. 3 shows a plan view of the arrangement of the first embodiment of the device according to the invention which is illustrated in FIG. 1, the water container 14 being in the first position, in which it is used as a water reservoir container for preparing coffee or tea. The profiled pipe 23 having the riser pipe 27 arranged in the interior is illustrated schematically. The position of the detachable contact 17 and of an outlet opening 28 which is provided on the lower side of the water container 14 can also be seen, in this position said outlet opening coinciding with the position of the inlet nozzle 25 which is provided on the base plate 11.

FIG. 4 shows a schematic cross section along the line IV-IV from FIG. 3, the coffeepot 21 and the filter unit 22 with distributor 24, and the metallic profiled pipe 23, with the exception of a mounting stub 29, having been omitted for the sake of clarity. FIG. 5 is a more detailed illustration of the section marked by a circle in FIG. 4. It can be seen that the opening 28 is made on the lower side 16 of the water container 14, and that a self-closing valve device 30 is fitted into this opening. The valve device 30 comprises a movable valve tappet 31 which in the rest position (cf. FIG. 8) is pressed against a valve seat 33 by a compression spring 32. For improved sealing, the valve tappet 31 has a surrounding silicone seal 34 in the bearing region on the seat 33. In the first position of the water container 14, illustrated in FIGS. 4 and 5, the inlet nozzle 25, which is provided on the upper side 19 of the first base plate 11, or a mandrel of the inlet nozzle engages in the outlet opening 28 on the bottom of the water container 14 and pushes the tappet 31 upward against the force of the compression spring 32, such that an opening is freed on the valve seat 33 and water can flow out of the container 14, through this opening, into the inlet nozzle 25 and to a through-flow heater 36 via a line 35. From there, the heated water rises via the riser pipe 27 in the interior of the profiled pipe 23 into the distributor 24 which is arranged above the filter unit 22 (cf. FIG. 1). FIGS. 4 and 5 also show a section through a heating device which is designed as a heating spiral 37 and is provided in the bottom of the water container 14 for its operation as a kettle. In the first position of the kettle which is illustrated in FIGS. 4 and 5, the heating spiral 32 is not in contact with its electrical supply devices which are arranged in the base 13, and it therefore cannot be activated. FIG. 5 furthermore clearly shows that a nonreturn valve 38 is provided in the line 35 in the vicinity of the inlet nozzle 25, and prevents the possibility of water which may already have been heated flowing back to the inlet nozzle 25 from the through-flow heater 36 when the water container 14 is removed.

FIG. 6 shows a plan view of the device from FIG. 1 which corresponds to the view from FIG. 3, the water container 14 now being in its second operating position which is turned clockwise through 900 in relation to the first position which is shown in FIG. 3, as made clear, in particular, by the position of the handle 15. The outlet opening 28 and the inlet nozzle 25 are no longer above one another.

FIG. 7 shows a section along line VII-VII from FIG. 6, whereas FIG. 8 in turn shows the region marked by a circle in FIG. 7 in more detail. It can be seen that no inlet nozzle engages in the outlet opening 28 of the water container 14 in the second position of said water container, so that, as is clear in particular from the detailed view from FIG. 8, the tappet 31 is pushed firmly against the valve seat 33 by the compression spring 32 such that the outlet opening is reliably sealed off by the silicone seal 34. In this position, the detachable electrical contact 17 ensures an electrically conducting connection between the power supply means 39 which are provided in the base 13 and the heating spiral 37 which is arranged in the bottom region of the container 14. Is is usual to provide on the kettle 14, or else in the first base plate 11, a switch 40 with which the user can switch on the heating spiral 32.

FIGS. 9 and 10 once again respectively show a plan view and a perspective view of the base 13 which comprises first base plate 11 and second base plate 12. These figures show, in particular, the depressions 41 which are provided in the first base 11 and in which the complementary knobs 18 which are provided on the lower side of the water container 14 can engage when the water container 14 is in the second position which is illustrated in FIG. 6, so that the electrical contact can be produced between the heating spiral 37 and the power supply means 39.

1. A device for preparing hot beverages comprising a water container removably arranged on a first base plate; a first heating device capable of heating the water contained in the water container; a filter unit arranged to receive ground coffee or tea leaves; (25) a water transfer arrangement for transferring water originating from the water container into the filter unit; the water transfer arrangement including a second heating device for heating the water to be transferred; a receiving vessel arranged downstream of the filter unit, wherein the water container can optionally be positioned in a first position, at which the water container is usable as a reservoir container for the water to be transferred into the filter unit, or in a second position, at which the water container is usable as a kettle.

2. The device as claimed in claim 1, wherein the first position the water container is offset at an angle in relation to the second position.

3. The device as claimed in claim 2, wherein the second position the water container is turned substantially through 90° with respect to the first position.

4. The device as claimed,in claim 1, wherein a bottom region of the water container has an outlet opening which can be closed by a self-closing valve device.

5. The device as claimed in claim 4, wherein the water transfer arrangement discharges into an inlet nozzle which is arranged on an upper side of the first base plate and opens the valve device when the water container is arranged in the first position.

6. The device as claimed in claim 5, wherein the water transfer arrangement comprises a nonreturn valve which is connected downstream of the inlet nozzle.

7. The device as claimed in claim 1, wherein the first base plate comprises an electrical supply which is in electrical contact with the first heating device by means of detachable contact-making device when the water container is in the second position of the water container.

8. The device as claimed in claim 7, wherein the detachable contact-making device comprise a 360° connector which is arranged on the upper side of the first base plate and interacts with a complementary socket which is arranged on the lower side of the water container.

9. The device as claimed in claim 7, wherein electrical contact is interrupted when the water container is in the first position of the water container.

10. The device as claimed in claim 2, wherein an upper side of the first base plate and a lower side of the water container are profiled such that the electrical contact is interrupted when the water container is turned from the second position into the first position.

11. The device as claimed in claim 1, including a second base plate for holding the receiving vessel.

12. The device as claimed in claim 11, wherein the first and second base plates are connected to one another to form a common base.

13. The device as claimed in claim 1, wherein the water container is arranged above the filter unit.

14. The device as claimed in claim 1, wherein the filter unit is fixed to a profiled pipe which runs vertically.

15. The device as claimed in claim 1, including a further electrically operated cordless kitchen appliance supportable on the base plate when the water container is removed.

16. The device as claimed in claim 15, wherein the further kitchen appliance is a cordless toaster or a cordless egg boiler.
